(19) United States
(12) Patent Application Publication
(10) Pub. No.: US 2017/0251422 A1
(43) Pub. Date: Aug. 31, 2017

(54) MOBILE DEVICE WITH MULTIPLE WIFI INTERFACES

(71) Applicant: Qualcomm Innovation Center, Inc., San Diego, CA (US)

(72) Inventors: Hamad Kadmany, Yarka (IL); Dedy Lansky, Zichron Yaacov (IL); Lior David, Kiriat Ata (IL)

(21) Appl. No.: 15/351,063

(22) Filed: Nov. 14, 2016

Related U.S. Application Data
(60) Provisional application No. 62/301,303, filed on Feb. 29, 2016.

(51) Int. Cl. H04W 48/08; H04W 28/20; H04L 29/08

(52) U.S. Cl. CPC H04W 48/08; H04L 67/02; H04W 28/20; H04W 84/12

(57) ABSTRACT

A mobile device with multiple WiFi transceivers and a method of using the same are disclosed. The mobile device may include at least two separate WiFi transceivers and at least two separate WiFi stacks, each of the WiFi stacks is coupled to one of the transceivers to enable separate control and concurrent use of the WiFi transceivers. Each of the WiFi stacks includes a WiFi application to provide a user interface to a corresponding one of the at least two WiFi transceivers; a WiFi driver configured to communicate with one of the WiFi transceivers; a WiFi supplicant module to communicate with one of the WiFi drivers; and a WiFi application programming interface (API) to expose control features to one of the WiFi applications. The mobile device includes a parameter consolidation module to generate a consolidated list of network parameters that satisfy requirements of both the WiFi transceivers.

### CLAIM OF PRIORITY UNDER 35 U.S.C. §119

The present Application for Patent claims priority to Provisional Application No. 62/301,303 entitled “MULTIPLE WIFI INTERFACES IN A COMPUTING DEVICE” filed Feb. 29, 2016, and assigned to the assignee hereof and hereby expressly incorporated by reference herein.

### FIELD OF THE DISCLOSURE

The present invention relates to transmission of data, and in particular, but not by way of limitation, the present invention relates to transmission of data via multiple local area network connections.

### BACKGROUND

Existing mobile devices are capable of communicating via WiFi protocols, such as 802.11a, and cellular communication protocols such as 3G or Long Term Evolution (LTE) protocols. When these existing mobile devices are in a location where both a WiFi connection is available and a cellular connection is available, the WiFi connection may take priority over the cellular connection for data communications.

In some mobile devices, multiple virtual WiFi devices may be presented to a user while the actual communications are sent via a single WiFi interface. Although it is technically possible to have multiple WiFi transceivers on a mobile device, there is currently no way to control multiple transceivers for concurrent operation. In the context of ANDROID-based mobile devices, for example, it is only possible to control one WiFi device from a graphical user interface (GUI). Thus, there exists a need for a more user friendly control of a plurality of WiFi devices.

### SUMMARY

According to an aspect, a mobile device is disclosed. The mobile device includes at least two separate WiFi transceivers and at least two separate WiFi stacks. Each of the WiFi stacks is coupled to one of the at least two WiFi transceivers to enable separate control and concurrent data communication via the WiFi transceivers. And each of the WiFi stacks includes a WiFi application configured to provide a user interface relative to a corresponding one of the at least two WiFi transceivers; a WiFi driver configured to communicate with one of the WiFi transceivers; a WiFi supplicant module configured to communicate with one of the WiFi drivers; and a WiFi application programming interface (API) to expose control features to one of the WiFi applications.

According to another aspect, a method for controlling and using a plurality of WiFi transceivers on a mobile device is disclosed. The method includes initializing a first WiFi transceiver for communication with a first remote device; initializing a second WiFi transceiver for communication with a second remote device; generating a consolidated list of network parameters that satisfy requirements of both the WiFi transceivers; and concurrently communicating, via the WiFi transceivers, with the first and second remote devices using the network parameters that satisfy requirements of both the WiFi transceivers.

### BRIEF DESCRIPTION OF THE DRAWINGS

FIG. 1 is a block diagram depicting a mobile device;

FIG. 2 is a flowchart depicting a method that may be carried out in connection with the mobile device depicted in FIG. 1;

FIG. 3 is a block diagram depicting stacks associated with multiple WiFi transceivers implemented in connection with an ANDROID operating system;

FIG. 4 is a diagram depicting network parameters; and

FIG. 5 is a block diagram depicting physical components of a mobile device.

### DETAILED DESCRIPTION

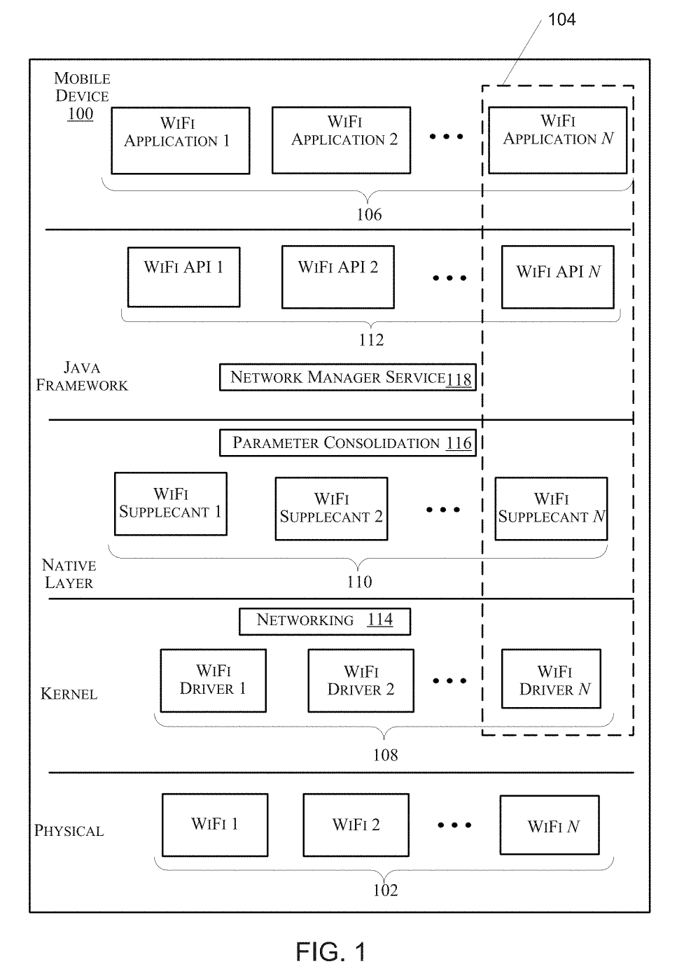

Referring first to FIG. 1, shown is a mobile device 100 that enables control over (and use of) multiple WiFi transceivers 102 that reside on the mobile device 100. The mobile device 100 may be realized by any of a variety of different types of devices including smartphones, netbooks, personal digital assistants, and devices in an Internet of things (IoT) environment.

Beneficially, the mobile device 100 may be used in a variety of different use cases that existing devices are incapable of. For example, a user of the mobile device 100 may utilize one of the N WiFi transceivers 102 to browse the Internet while another of the N WiFi transceivers 102 is concurrently used to copy files to a smartphone via a peer-to-peer connection. As another example, one of the N WiFi transceivers 102 may be used to create a hotspot for other WiFi-enabled devices in close proximity to the mobile device 100 while another one of the WiFi transceivers 102 may be concurrently used to communicate with a large-screen display to enable a display of the mobile device 100 to be mirrored on the large screen display. In yet another use case, a user may utilize one of the N WiFi transceivers 102 to browse the Internet while another of the N WiFi transceivers 102 is used to back up files on the communication device to the cloud.

As shown, the mobile device 100 includes N WiFi transceivers 102 at a physical layer and N corresponding WiFi stacks 104 (one of the N WiFi stacks 104 is demarked by dashed lines in FIG. 1) that span from a kernel layer to an application layer of the mobile device 100. As shown, each stack includes: one of N WiFi applications 106 configured to provide a user interface relative to a corresponding one of the N WiFi transceivers 102; one of N WiFi drivers 108 configured to communicate with one of the WiFi transceivers 102; one of N WiFi supplicant modules 110 configured to communicate with one of the WiFi drivers 108; and one of N WiFi application programming interfaces (APIs) 112 to expose control features to one of the N WiFi applications 106.

The depiction of components in FIG. 1 is intended to be a logical depiction of functional components that are relevant to embodiments disclosed herein. Thus, it is not intended to depict the many other components known to those of ordinary skill the art that may be implemented. The embodiment depicted in FIG. 1 is also intended to be a general depiction of components that may be implemented in connection with an ANDROID operating system.

Unlike prior art devices, the depicted embodiment includes at least two physical

WiFi transceivers 102 and at least two separate WiFi stacks 104 for concurrent communication. A beneficial aspect of the mobile device 100 is that it enables a user to separately control each of the N WiFi transceivers 102. The WiFi application 106 in each stack 104 is configured to provide a user interface to provide a user-facing control for each WiFi transceiver 102. For example, each WiFi application 106 is configured to enable a user to scan for WiFi networks, select a particular WiFi network, and store authentication credentials for each WiFi network. In addition, a user may associate each of the WiFi transceivers 102 with one or more other applications on the mobile device 100.

For example, the user may select WiFi transceiver 1 to be a default WiFi transceiver in connection with use of a web browser while the user may select WiFi transceiver 2 to be a default WiFi transceiver 102 for a mirroring application that enables the mobile device 100 to mirror its display on another remote display.

The WiFi supplicant 110 in each stack 104 may be realized as a Wi-Fi Protected Access (WPA) client and Institute of Electrical and Electronics Engineers (IEEE) 802.1X supplicant. For example, the WiFi supplicant may implement WPA key negotiation with a WPA Authenticator and extensible authentication protocol (EAP) authentication with a remote authentication server. In addition, it may control the roaming and IEEE 802.11 authentication/association of a corresponding WiFi driver 108. This capability is useful for connecting to a password protected wireless access point.

The WiFi driver 108 in each stack provides a software interface to each corresponding WiFi transceiver 102; thus enabling access (e.g., to the Java Framework and native layer) to hardware functions of the WiFi transceiver 102 without needing to know precise details of the WiFi transceiver 102 being used. Each WiFi driver 108 is hardware dependent and independent of the other WiFi drivers 108 on the mobile device 100 so that each WiFi driver 108 may operate concurrently with other WiFi drivers 108 while remaining independent.

As one of ordinary skill in the art in view of this disclosure will appreciate, the networking module 114 is configured to route traffic to the appropriate WiFi driver (and hence, WiFi transceiver 102) based upon rules that are pushed down to the networking module 114 when a WiFi application 106 initiates operation of a WiFi transceiver 102. The networking module 114 may maintain a network routing table based upon the rules so that traffic is routed to a particular WiFi transceiver 102 that has been associated with a particular type of traffic (e.g., streaming video traffic) or particular application (e.g., a web browser).

The parameter consolidation module 116 is generally configured to generate a consolidated list of network parameters that satisfy requirements of two or more of the WiFi transceivers 102. As discussed in more detail further herein, to provide improved performance (in terms of traffic throughput) of a network connection, parameters are configured in order to improve the overall performance of traffic in and out of the mobile device 100.

In prior art mobile devices (e.g., prior ANDROID-based devices), there is an assumption that, at any given time, all data traffic will be sent through one LAN transceiver (e.g., either through an LTE connection, a WiFi connection, or an Ethernet connection). Due to this assumption, prior art ANDROID devices configure network parameters based on the active transceiver's requirements. In contrast, in the depicted embodiment, traffic concurrency is supported. More specifically, traffic may be running concurrently on two or more of the WiFi transceivers 102. As a consequence, the mobile device 100 may operate so there no single active WiFi transceiver 102, and each WiFi transceiver 102 may have different network parameters to achieve its best performance.

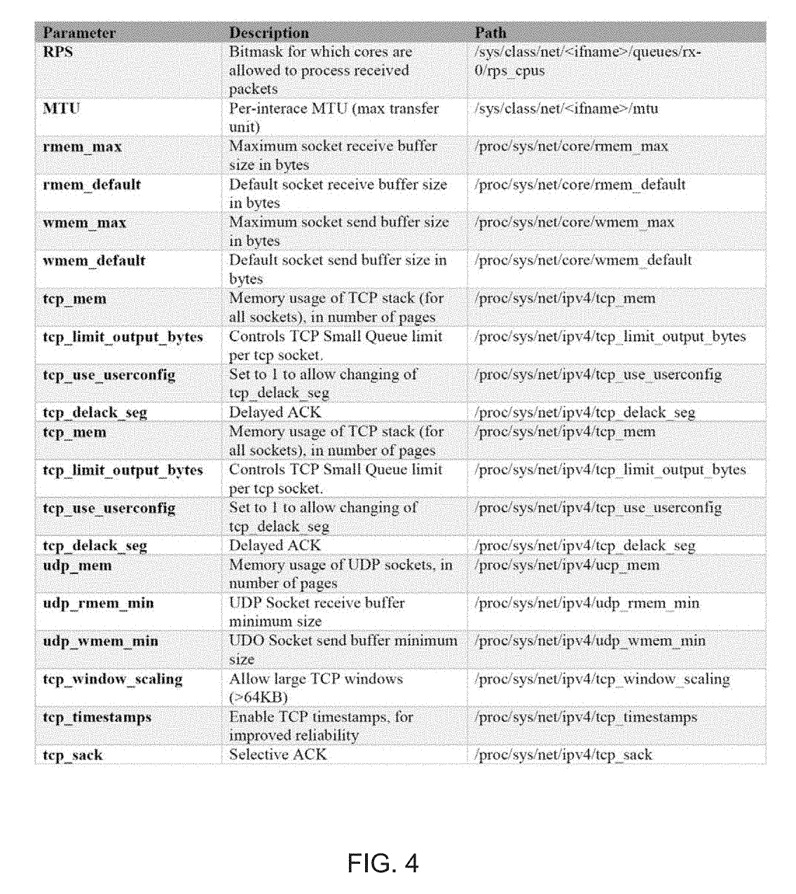

More specifically, the parameter consolidation module 116 obtains the required network parameters for each WiFi transceiver 102 and “merges” them to obtain a consolidated list of parameters that satisfies the requirements of two or more of the WiFi transceivers 102. The parameters are then pushed to the WiFi drivers 108 at the kernel level. In this way, the two more WiFi transceivers 102 that are concurrently operating have the required performance needed. As described further herein, FIG. 4 includes a table that describes exemplary network parameters.

The network manager service 118 in this embodiment is configured to receive calls from the WiFi applications 106 that are intended to set network parameters at the kernel layer for a single WiFi transceiver 102, and instead redirect those calls so that the parameter consolidation module 116 is used instead to set the network parameters.

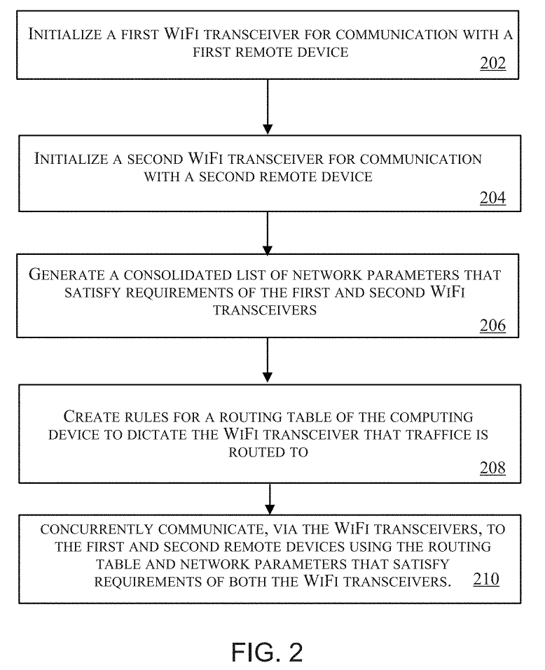

Referring next to FIG. 2, shown is a flowchart that depicts a method for controlling and using a plurality of WiFi transceivers that may be carried out in connection with the embodiment depicted in FIG. 1. As shown, a first WiFi transceiver is initialized for communication with a first remote device (Block 202) and a second WiFi transceiver is initialized for communication with a second remote device (Block 204). A consolidated list of network parameters that satisfies requirements of the first and second WiFi transceivers 102 is generated (Block 206), and rules are created for a routing table of the mobile device 100 to dictate the WiFi transceiver that traffic is routed to (Block 208). As shown, the mobile device 100 then concurrently communicates, via the WiFi transceivers 102, to the first and second remote devices using the routing table and network parameters that satisfy requirements of both the WiFi transceivers 102 (Block 210).

It should be noted that the flowchart in FIG. 2 is not intended to convey a particular order in which steps must be carried out. For example, one possible order of steps may be carried out as follows: the first WiFi transceiver is initialized; network parameters are generated for the first WiFi transceiver; the second WiFi transceiver is initialized; and then the network parameters are regenerated to satisfy requirements of the first and second WiFi transceivers. It should also be recognized that the network parameters may be automatically regenerated as WiFi transceivers are initialized and de-initialized during operation.

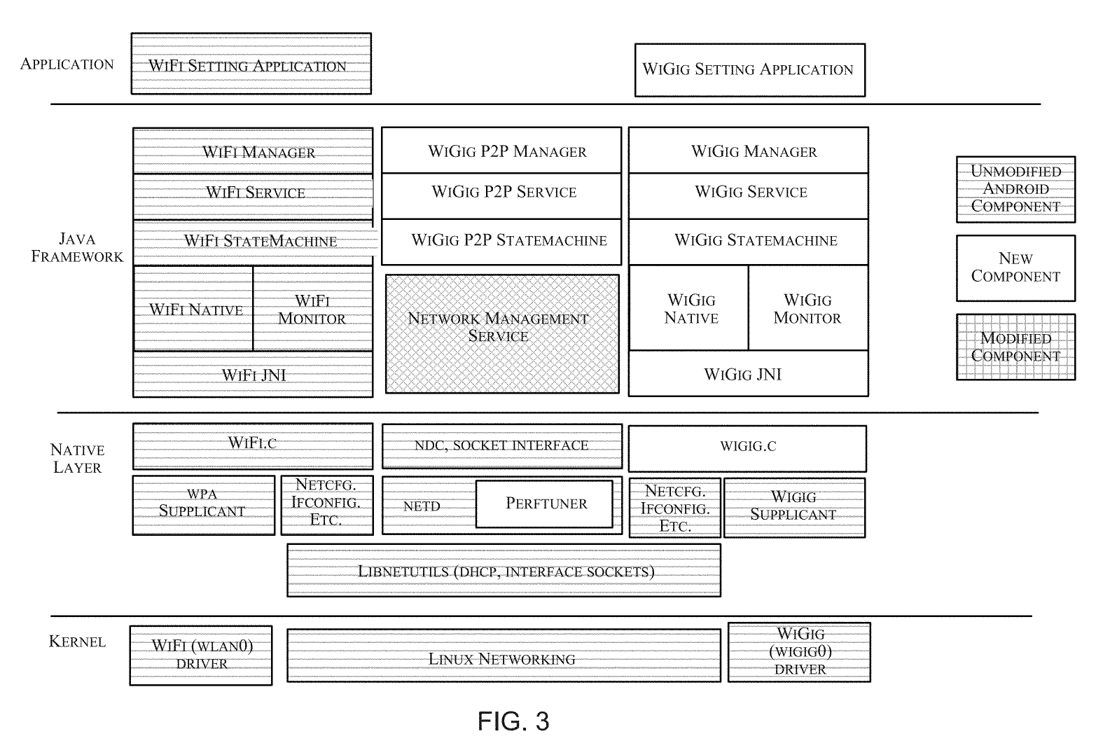

Referring next to FIG. 3, shown is a block diagram of an embodiment that is implemented in the context of an ADROID-based operating system. As shown, unmodified, typical components of an ANDROID operating system are shown with a parallel hatch pattern, new components are shown as blocks without a pattern, and modified components are shown with a cross hatch pattern.

The depicted, additions, changes, and modifications enable support for control over more than one WiFi transceiver (e.g., so that a user may control multiple WiFi transceivers) in connection with an ANDROID operating system. Moreover, once an additional WiFi transceiver is initialized, the depicted embodiment provides proper concurrent routing of traffic through the WiFi transceivers. In addition, the depicted embodiment provides a consolidated list of network parameters that satisfy requirements of both the WiFi transceivers.

The depicted embodiment is relatively insensitive to future changes in the existing ANDROID stack while full concurrency between the WiFi transceivers is provided in different modes (e.g., client, soft access-point and peer-to-peer modes of operation).

In FIG. 3, a first WiFi transceiver (not shown, but named wlan0) is implemented along with a second WiFi transceiver (not shown, but named wigig0). The w1an0 transceiver may be any type of WiFi transceiver (e.g., any of the 802.11 family transceivers), and the wigig0 transceiver in the depicted embodiment is an 802.11ad WiFi transceiver. To avoid issues, the name of the second WiFi driver (wigig0) is set to a different name than wlan0, and although not required, wlan0 may be used as a primary interface. It should be recognized that the second WiFi transceiver may operate in accord with other WiFi protocols in other embodiments.

As shown, the prior unmodified ANDROID stack (shown with the parallel hatch pattern) is limited because the stack from the top down assumes that only one driver (wlan0) and one physical WiFi transceiver exist.

In the embodiment depicted in FIG. 3, many existing components are reused in the new stack that is created for the wigig0 transceiver. But in addition, a perftuner module is implemented to realize the parameter consolidation module 116 functions described with reference to FIG. 1. In addition, the network management service has been modified to interact with the perftuner module.

The WiGig manager is a new API (that the operating system exposes) that enables control over the wigig0 transceiver. For example, the WiGig manager enables the WiGig Setting Application to scan, see WiFi networks, and selectively connect to them. The WiGig service is a new, separate system service for the wigig0 WiFi transceiver to decouple control for each WiFi transceiver so each operates independently.

The WiGig Service receives requests from the WiGig Setting Application via the WiGig manager and executes requests through the WiGig StateMachine. The WiGig StateMachine is configured to track the state of the wigig0 transceiver; initialize the WiGig driver, start the wigig_supplicant instance and makes sure it is running; and then the WiGig StateMachine may issue scan commands and receive event information (e.g., indicating that a network is found) and provide the scan results to the upper layer WiGig Setting Application. Thus, the WiGig StateMachine functions to track the WiGig driver.

The WiGig Native, WiGig Monitor, and WiGig Java Native Interface (JNI) in the Java framework tunnel to native layer environment. More specifically, the WiGig Native issues commands from the WiGig StateMachine to wigig.c. And the WiGig Monitor communicates event information from wigig.c to the WiGig state machine. Wigig.c is a main entry point to the native environment of the WiGig stack. Wigig.c includes APIs that are exposed to the upper layer WiGig StateMachine to initialize the WiGig driver, to start the wigig_supplicant, issue commands to the wigig_supplicant, and wigig.c relays requests to the wigig_supplicant.

In turn, the wigig_supplicant communicates to the WiGig driver in the kernel to relay commands, and the WiGig driver talks to the actual physical wigig0 WiFi transceiver. The wigig_supplicant may operate as a Wi-Fi Protected Access (WPA) client and IEEE 802.11ad supplicant.

The WiGig Service also operates to add rules to a routing table used by the Linux networking module to route concurrent traffic to the WiFi transceivers. Although the existing ANDROID operating system has a network agent, the default rules route all data through a single WiFi transceiver. The rules pushed to the Linux networking module in the present embodiment allow for concurrent traffic.

As one of ordinary skill in the art will appreciate, all data will be tagged with an address, and the rules pushed to the routing table will enable the Linux networking module to know which WiFi transceiver to route traffic to.

Another aspect of the embodiment depicted in FIG. 3 is the perftuner module, which is an addition to the netd module of the ANDROID operating system. The native layer of the ANDROID operating system may be adapted to include the perftuner module, which is configured to generate the consolidated list of network parameters. The perftuner module corresponds to the parameter consolidation module 116 depicted in FIG. 1, and operates to obtain the required network parameters for the wlan0 transceiver and the wigig0 transceiver and “merge” the parameters to obtain a consolidated list of parameters that satisfies the requirements of both the wlan0 transceiver and the wigig0 transceiver. The parameters are then pushed to the LINUX kernel network stack. In this way, the wlan0 transceiver and the wigig0 transceiver are configured, using the consolidated list, to operate at a high level of performance.

Referring to FIG. 4, shown is a table that describes exemplary network parameters. In addition, the third column of the table includes a path (specific to the LINUX kernel) corresponding to each parameter.

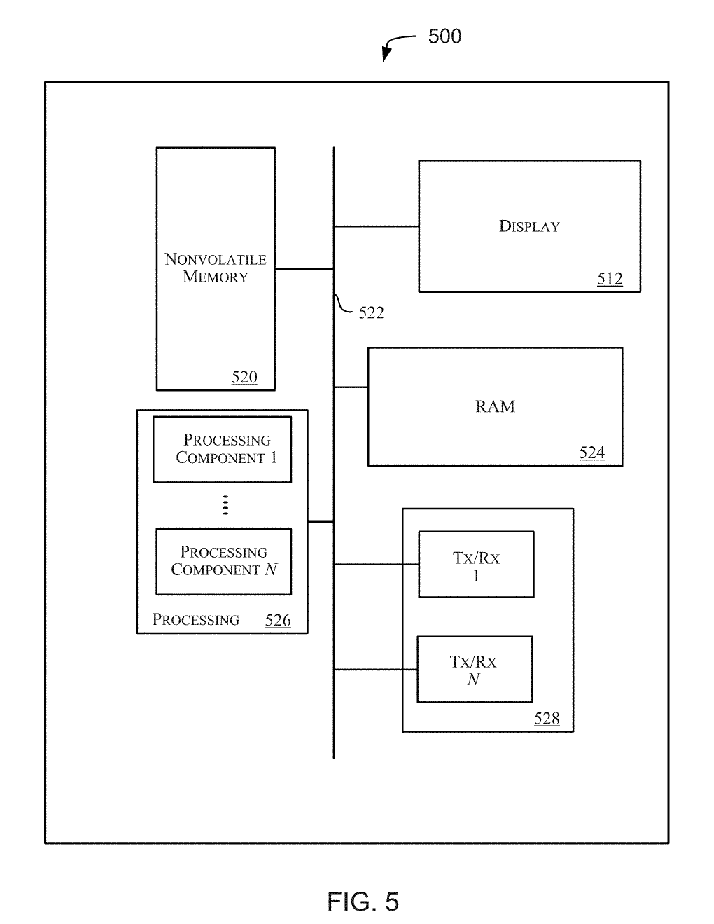

Referring next to FIG. 5, shown is a block diagram depicting high-level physical components of an exemplary mobile device 500 that may be utilized to realize a mobile device 100 of the present disclosure. As shown, the mobile device 500 in this embodiment includes a display portion 512, and nonvolatile memory 520 that are coupled to a bus 522 that is also coupled to random access memory (“RAM”) 524, and a processing portion (which includes N processing components) 526. Although the components depicted in FIG. 5 represent physical components, FIG. 5 is not intended to be a hardware diagram; thus many of the components depicted in FIG. 5 may be realized by common constructs or distributed among additional physical components. Moreover, it is certainly contemplated that other existing and yet-to-be developed physical components and architectures may be utilized to implement the functional components described with reference to FIG. 5.

This display portion 512 generally operates to provide a presentation of content to a user. In several implementations, the display is realized by a liquid crystal display (LCD) or organic light emitting diode (OLED) display. In general, the nonvolatile memory 520 is a non-transitory tangible processor-readable storage medium that functions to store (e.g., persistently store) data and executable code including code that is associated with the functional components described herein, in addition to other functions and aspects of the nonvolatile memory unique to the present disclosure. In some embodiments for example, the nonvolatile memory 520 includes bootloader code, modem software, operating system code, file system code, and code to facilitate the implementation of one or more portions of the mobile device depicted in FIGS. 1 and 3. For example, the nonvolatile memory 520 may include processor-readable (e.g., executable) instructions to carry out the functions of each component of the WiFi stacks 104, the networking module 114, the parameter consolidation module 116, and the network manager service 118.

In many implementations, the nonvolatile memory 520 is realized by flash memory as described throughout the disclosure (e.g., NAND or ONENANDTM memory), but it is certainly contemplated that other memory types may be utilized, such as traditional hard disk drives. Although it may be possible to execute the code from the nonvolatile memory 520 the executable code in the nonvolatile memory 520 is typically loaded into random access memory (RAM) 524 and executed by one or more of the N processing components in the processing portion 526. In many embodiments, the system memory may be implemented through the nonvolatile memory 520, the RAM 524, or some combination thereof.

The N processing components in connection with RAM 524 generally operate to execute the instructions stored in nonvolatile memory 520 to effectuate the functional components described herein. As one of ordinarily skill in the art will appreciate, the processing portion 526 may include a video processor, modem processor, DSP, and other processing components. The depicted N transceiver components 528 may each operate according to a different wireless protocol (e.g., 802.11 family protocols) and may communicate with the WiFi drivers depicted in FIG. 1 and the wlan0 and wigig drivers depicted in FIG. 3.

In conclusion, embodiments of the present invention improve provide user control over, and concurrent use of, multiple WiFi transceivers. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention.

What is claimed is:

1. A mobile device comprising:
at least two separate WiFi transceivers;
at least two separate WiFi stacks, each of the WiFi stacks is coupled to one of the at least two separate WiFi transceivers to enable separate control and concurrent data communication via the at least two WiFi transceivers, each of the WiFi stacks including:
a WiFi application configured to provide a user interface relative to a corresponding one of the at least two separate WiFi transceivers;
a WiFi driver configured to communicate with the corresponding one of the at least two separate WiFi transceivers;
a WiFi supplicant module configured to communicate with the WiFi driver; and
a WiFi application programming interface (API) to expose control features of the corresponding one of the at least two separate WiFi transceivers to the WiFi application.

2. The mobile device of claim 1, including:
a parameter consolidation module configured to generate a consolidated list of network parameters that satisfy requirements of both the WiFi transceivers.

3. The mobile device of claim 2, wherein a native layer of the ANDROID operating system is adapted to include a perftuner module configured to generate the consolidated list of network parameters.

4. The mobile device of claim 1, wherein at least one of the WiFi transceivers is an 802.11ad transceiver.

5. The mobile device of claim 1, wherein each of the WiFi stacks is configured to operate with an ANDROID operating system.

6. The mobile device of claim 4 wherein a StateMachine is configured to add rules to a routing table to enable traffic to be concurrently routed to the WiFi transceivers.

7. A method for controlling and using a plurality of WiFi transceivers on a mobile device, the method comprising:
initializing a first WiFi transceiver for communication with a first remote device;
initializing a second WiFi transceiver for communication with a second remote device;
generating a consolidated list of network parameters that satisfy requirements of both the WiFi transceivers; and
concurrently communicating, via the WiFi transceivers, with the first and second remote devices using the network parameters that satisfy requirements of both the WiFi transceivers.

8. The method of claim 7, including:
obtaining required network parameters for both WiFi transceivers;
merging the network parameters to obtain a consolidated list that satisfies requirements of both devices; and
configuring the WiFi transceivers using the consolidated list to operate at a required performance for both WiFi transceivers.

9. The method of claim 7, including:
providing a settings application for each of the WiFi transceivers to enable a user to separately control each of the WiFi transceivers.

10. The method of claim 9, including:
creating and pushing rules to a routing table of the mobile device to enable traffic to be concurrently routed to the WiFi transceivers.

11. A non-transitory tangible processor-readable storage medium encoded with instructions for executing a method for controlling and using a plurality of WiFi transceivers on a mobile device, the method comprising:
initializing a first WiFi transceiver for communication with a first remote device;
initializing a second WiFi transceiver for communication with a second remote device;
generating a consolidated list of network parameters that satisfy requirements of both the WiFi transceivers; and
concurrently communicating, via the WiFi transceivers, to the first and second remote devices using the network parameters that satisfy requirements of both the WiFi transceivers.

12. The non-transitory tangible processor-readable storage medium of claim 11, the method including:
obtaining required network parameters for both WiFi transceivers;
merging the network parameters to obtain a consolidated list that satisfies requirements of both devices;
configuring the WiFi transceivers using the consolidated list to obtain a required performance for both WiFi transceivers.

13. The non-transitory tangible processor-readable storage medium of claim 11, the method including:
providing a settings application for each of the WiFi transceivers to enable a user to separately control each of the WiFi transceivers.

14. The non-transitory tangible processor-readable storage medium of claim 13, the method including:
creating and pushing rules to a routing table of the mobile device to enable traffic to be concurrently routed to the WiFi transceivers.
